(19) United States
(12) Patent Application Publication
(10) Pub. No.: US 2005/0245684 A1
(43) Pub. Date: Nov. 3, 2005

(54) Water absorbing agent and method for the production thereof

(76) Inventors: Thomas Daniel, Waldsee (DE); Ulrich Riegel, Frankfurt (DE); Mark Elliott, Ludwigshafen (DE); Matthias Weismantel, Jossgrund-Oberndorf (DE); Martin Wendker, Worms (DE)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/523,913

(22) PCT Filed: Aug. 25, 2003
(86) PCT No.: PCT/EP03/09406

§ 371 Date: Feb. 7, 2005

(30) Foreign Application Priority Data
Aug. 26, 2002 (DE) 102 39 074.6

(51) Int. Cl. C08F 8/30

(52) U.S. Cl. 525/178

(57) ABSTRACT

Described is a water absorbent comprising (a) particles of a water absorbent polymer, and (b) a nitrogenous polymer containing from 5 to 17 mol/kg, based on the total weight of the nitrogenous polymer, of protonatable nitrogen atoms. The water absorbent possesses an improved property profile featuring high absorptive capacity, improved fluid transmission and high wet strength.

### DESCRIPTION

The present invention relates to a water absorbent and to processes for producing it.

Water absorbent polymers, which are also referred to as hydrogel-forming polymers or superabsorbent polymers (hereinafter abbreviated to SAPs), are known. They are networks of flexible hydrophilic polymers, which can be not only ionic but also nonionic in nature. They are capable of absorbing and binding aqueous fluids by forming a hydrogel. A comprehensive survey of SAPs, their use and their manufacture is given in F. L. Buchholz and A. T. Graham (editors) in “Modern Superabsorbent Polymer Technology”, Wiley-VCH, New York, 1998.

SAPs are used in particular in hygiene articles such as diapers, incontinence pants and briefs, sanitary napkins and the like to absorb body fluids. There has been an increasing tendency in recent years to make hygiene articles ever thinner and smaller for esthetic reasons and for environmental reasons. For this, the SAPs must provide good liquid distribution and transmission and also a high swellability. A frequent problem is here that the superabsorbent at the point of ingress of the fluid swells to a substantial extent and forms a barrier layer for subsequent amounts of fluid. This prevents any transmission and distribution of the fluid in the absorbent core. This superabsorbent phenomenon is known as gel-blocking. Subsequent amounts of fluid are then no longer taken up by the absorbent core, with the consequences of uncontrolled distribution of the fluid on the diaper surface and leakage of the fluid in the extreme case. Another important requirement in this connection is that the SAPs have a high gel strength in the swollen state. Gels having little gel strength are deformed under pressure, for example the pressure exerted by the bodyweight of the wearer, and clog the pores of the absorbent core.

True, the gel strength and hence the permeability of an SAP can be improved by increasing the crosslink density, but this reduces the ultimate absorption capacity of the SAP. To achieve a high permeability, the pores in the SAP have to have a large diameter and hence the fraction of SAP particles having a small size has to be reduced, which is costly and inconvenient.

A further problem of water-swellable polymers is their extractable content. Water-swellable polymers are produced in such a way that they will always contain a certain fraction of extractable constituents such as sodium polyacrylate. In addition, the polymer network can break in the course of swelling, further increasing the extractable content in use. This applies especially to strongly swollen gels. When the water-swellable polymers come into contact with body fluids, the extractable fractions are washed out. They thicken the fluid, migrate to the surface and hence hinder ingress of further fluid, ie the higher the fraction of extractables, the lower the fluid transmission.

EP-A 0 761 241 describes absorbing agents comprising an absorbent resin and a water-insoluble inorganic powder and/or a polyamine having an average molecular weight of 5 000 or more. The water-insoluble inorganic powder is preferably silicon dioxide and the polyamine is preferably polyethyleneimine.

U.S. Pat. No. 6,099,950 proposes improving swellability and fluid transmission and increasing wet strength by using polymers such as polyamines and polyimines, the polymer being capable of reaction with at least one constituent of urine, in water-absorbing compositions. Suitable amines are said to include for example polyvinylamine and polyallylamine.

To improve gel permeability while retaining swellability, prior German patent application 101 02 429.0 recommends water absorbents comprising particles of a water absorbent polymer whose surface is associated with a water-insoluble metal phosphate.

However, the performance profile of the water absorbents described is not satisfactory in every respect. There is a need for water absorbents which combine a very high fluid transmission performance or permeability (SFC), ie are very efficient at letting fluid pass through the swollen gel layer, with a very high absorptive capacity. The absorbents shall further possess a high wet strength.

It is an object of the present invention to provide water absorbents possessing improved performance properties, especially an increased permeability, high absorptive capacities both under load and under free swell conditions and high wet strength.

We have found that this object is achieved by a water absorbent comprising
(a) particles of a water absorbent polymer, and
(b) a nitrogenous polymer containing from 5 to 17 mol/kg, preferably from 5.5 to 15 mol/kg, especially from 6.0 to 12 mol/kg and most preferably from 6.5 to 10 mol/kg, based on the total weight of the nitrogenous polymer, of protonatable nitrogen atoms.

The present invention also provides a process for producing the water absorbent of the present invention.

The water absorbent of the present invention is typically characterized by one or more, especially all, of the following properties:
a particle size distribution wherein more than 98% by weight of the particles are from 100 to 850 μm, preferably from 100 to 600 μm and especially from 100 to 500 μm, in size,
a Saline Flow Conductivity of at least 30×10⁻⁷ cm³·s/g, preferably of at least 60×10⁻⁷ cm³·s/g and especially at least 100×10⁻⁷ cm³·s/g,
a Ball Burst Strength (30 min) [BBS (30 min)] of at least 50 gf, preferably at least 90 gf and especially at least 110 gf,
a Ball Burst Strength (16 h) [BBS (16 h)] of at least 50 gf, preferably at least 75 gf and especially at least 100 gf,
a quotient [BBS (30 min)—BBS (16 h)]/BBS (30 min) of less than 0.8, preferably less than 0.5 and especially less than 0.4,
CRC of from 20 to 33 g/g,
an AUL (0.7 psi) of from 17 to 27 g/g.

It has been determined that, surprisingly, the properties of the water absorbent, such as in particular the fluid transmission (SFC), swellability (CRC), Absorbency Under Load (AUL 0.7 psi), depend substantially on the fraction of protonatable nitrogen atoms in the nitrogenous polymer (hereinafter also: “charge density”). Thus, nitrogenous polymers having a charge density in the specified range provide a distinctly improved fluid transmission performance (SFC), an improved swellability (CRC), an improved Absorbency Under Load (AUL 0.7 psi) for comparable wet strength (BBS) as compared with nitrogenous polymers having a charge density outside the specified range.

By “protonatable nitrogen atoms” are meant nitrogen atoms in functional groups that are protonatable (in principle) in an aqueous medium, irrespectively of whether the groups are indeed present in protonated form at a given pH. The groups in question are preferably primary amino groups.

Useful nitrogenous polymers include the products of the controlled hydrolysis of homo- and copolymers of N-vinylcarboxamides and/or N-vinylcarboximides. A controlled hydrolysis will detach the acyl group(s) from a portion of the polymerized N-vinylcarboxamide or N-vinylcarboximide units by the action of acids, bases or enzymes to leave vinylamine units.

Useful N-vinylcarboxamides include in principle both open-chain and cyclic N-vinylcarboxamides. Preferred N-vinylcarboxamides are open-chain N-vinylcarboxamides, especially those open-chain N-vinylcarboxamides whose hydrolysis yields a primary amine. Examples of particularly suitable N-vinylcarboxamides are N-vinylformamide, N-vinylacetamide and N-vinylpropionamide, especially N-vinylformamide. Examples of suitable N-vinylimides are N-vinylsuccinimide and N-vinylphthalimide. The monomers mentioned can be polymerized either alone or in admixture with each other.

In a preferred embodiment, the nitrogenous polymer is a homopolymer of N-vinylformamide having a degree of hydrolysis in the range from 30 to 80 mol % and preferably in the range from 40 to 60 mol %. The production of such partially hydrolyzed polyvinylamides (colloquially also known as “partially hydrolyzed polyvinylamines”) is described for example in DE 31 28 478, which is hereby fully incorporated herein by reference. Solutions of fully or partially hydrolyzed polyvinylformamides are commercially available and are sold for example by BASF Aktiengesellschaft under the trade names of Basocoll®, Luredur® and also Catiofast®.

It is particularly advantageous to carry out the hydrolysis in an alkaline medium, for example in a pH range from 9 to 14. This pH value is preferably set by adding aqueous alkali metal hydroxide such as aqueous sodium hydroxide solution or aqueous potassium hydroxide solution. However, it is also possible to use ammonia, amines and alkaline earth metal hydroxides such as calcium hydroxide. The hydrolysis can likewise be carried out in an acidic medium, for example in a pH range from 0 to 3. Suitable acids are carboxylic acids, such as formic acid, acetic acid, propionic acid, sulfonic acids such as benzenesulfonic acid or toluenesulfonic acid, or inorganic acids such as hydrochloric acid, sulfuric acid, phosphoric acid or hydrobromic acid.

The concentration of the acid or base can be used to adjust the degree of hydrolysis of the polyvinylamine. It is customary to use the base in an equimolar amount per mole of acyl group equivalent to be hydrolyzed in the nitrogenous polymer; that is, it is customary to use from 0.3 to 0.8 equivalent of a base per acyl group equivalent in the nitrogenous polymer to achieve a degree of hydrolysis in the range from 30 to 80 mol % and it is customary to use from 0.4 to 0.6 equivalent of a base per acyl group equivalent in the nitrogenous polymer to achieve a degree of hydrolysis in the range from 40 to 60 mol %.

The hydrolysis can be carried out in various solvents such as water, alcohols, ammonia and amines or mixtures, for example of water and alcohols or aqueous solutions of ammonia and/or amines. It is preferable to carry out the hydrolysis in water or in alcohols such as methanol, ethanol, isopropanol and n-butanol. The by-products of the hydrolysis are removed from the system during or after the hydrolysis. The reaction temperature is customarily in a temperature range from 40 to 180° C. If appropriate, all of the solvent is removed or the hydrolysis product is concentrated to the desired degree.

Alternatively, the nitrogenous polymer used can be a copolymer which contains copolymerized units of monomers having side groups including protonatable nitrogen atoms and copolymerized units of monomers without protonatable nitrogen atoms in a suitable ratio. The charge density CD is calculated by the following equation:

$$CD = \frac{{x}_{N}}{{x}_{N} {M}_{N} + {x}_{O} {M}_{O}}$$

where x_{N} is the molar fraction in the copolymer of the monomer which includes protonatable nitrogen atoms, X₀ is the molar fraction in the copolymer of the monomer without protonatable nitrogen atoms, M_{N} is the molecular weight of the monomer including protonatable nitrogen atoms and M_{O} is the molecular weight of the monomer without protonatable nitrogen atoms. The term “molar fraction” here refers to the composition of a polymer chain which is representative of the given polymer.

Examples of suitable monomers having side groups which include protonatable nitrogen atoms are allylamine, di(C₁-C₄-alkyl)aminoethyl acrylate, N-di(C₁-C₄-alkyl)-aminoethylacrylamide, N-di(C₁-C₄-alkyl)aminopropylacrylamide and the like.

Instead of monomers having side groups which include protonatable nitrogen atoms it is also possible to use precursor monomers from which the protonatable nitrogen atoms can be released by suitable aftertreatment. The side groups of the precursor monomers may include for example protected amino groups from which the protecting group is detached after polymerization. Suitable precursor monomers include the abovementioned N-vinylcarboxamides and/or N-vinylcarboximides, which form vinylamine units on full or partial hydrolysis. The amount of monomers without protonatable nitrogen atoms and/or the degree of hydrolysis of the units derived from the precursor monomers is adjusted in such a way that the desired charge density is obtained. Preference is given to copolymers wherein all the units derived from the precursor monomers, such as N-vinylformamide, are hydrolyzed.

Suitable monomers without protonatable nitrogen atoms include ethylenically unsaturated C₃ to C₆ carboxylic acids, for example acrylic acid, methacrylic acid, maleic acid, crotonic acid, itaconic acid and vinylacetic acid. Useful comonomers further include vinyl acetate, acrylonitrile and methacrylonitrile.

An example of a suitable nitrogenous polymer is the hydrolysis product of a copolymer of vinylformamide and acrylic acid. The vinylformamide fraction is for example in the range from 40 to 80 mol % with the acrylic acid fraction being in the range from 60 to 20 mol %.

The weight average molecular weight of the nitrogenous polymer is preferably in the range from 10 000 to 500 000 daltons, more preferably in the range from 50 000 to 450 000 daltons and especially in the range from 100 000 to 420 000 daltons.

The nitrogenous polymer is used in an amount which is typically in the range from 0.001% to 5% by weight, preferably in the range from 0.01% to 2% by weight, especially in the range up to 1.5% by weight and most preferably in the range up to 1.0% by weight, based on the weight of the water absorbent polymer.

In one embodiment, the water absorbent of the present invention further includes at least one finely divided water-insoluble salt selected from inorganic and organic salts and mixtures thereof. By water-insoluble salt is meant for the purposes of the present invention a salt which has a water solubility of less than 5 g/l, preferably less than 3 g/l, especially less than 2 g/l and most preferably less than 1 g/l at pH 7, 25° C. and 1 bar. By using the water-insoluble salt it is possible to reduce the water absorbent's tackiness due to the nitrogenous polymer, during application.

Examples of suitable cations in the water-insoluble salt are Ca²⁺, Mg²⁺, Al³⁺, Sc³⁺, Y³⁺, Ln³⁺ (where Ln represents lanthanides), Ti⁴⁺, Zr⁴⁺, Li⁺ or Zn²⁺. Examples of suitable inorganic anionic counterions are carbonate, sulfate, bicarbonate, orthophosphate, silicate, oxide or hydroxide. Examples of suitable organic anionic counterions are oxalate and tartrate. It is advantageous to select a counterion which does not form water-insoluble complexes with the nitrogenous polymer. Where a salt occurs in various crystal forms, all crystal forms of the salt are compounded. The water-insoluble inorganic salts are preferably selected from calcium sulfate, calcium carbonate, calcium phosphate, calcium silicate, calcium fluoride, apatite, magnesium phosphate, magnesium hydroxide, magnesium oxide, magnesium carbonate, dolomite, lithium carbonate, lithium phosphate, zinc oxide, zinc phosphate, oxides, hydroxides, carbonates and phosphates of the lanthanides, sodium lanthanide sulfate, scandium sulfate, yttrium sulfate, lanthanum sulfate, scandium hydroxide, scandium oxide, aluminum oxide, hydrated aluminum oxide and mixtures thereof. The term “apatite” comprehends fluoroapatite, hydroxyl apatite, chloroapatite, carbonate apatite and carbonate fluoroapatite. The organic water-insoluble salts are preferably selected from calcium oxalate, scandium oxalate, the oxalates of the lanthamides and mixtures thereof. Of particular suitability are the calcium and magnesium salts such as calcium carbonate, calcium phosphate, magnesium carbonate, calcium oxide, magnesium oxide, calcium sulfate and mixtures thereof.

The average particle size of the finely divided water-insoluble salt is typically less than 500 μm, preferably less than 200 μm, especially less than 100 μm, particularly preferably less than 50 μm and very particularly preferably less than 20 μm and most preferably in the range from 1 to 10 μm.

If used, the finely divided water-insoluble salt is used in an amount from 0.001% to 20% by weight, preferably less than 10% by weight, especially from 0.001% to 5% by weight, very particularly preferably from 0.001% to 2% by weight and most preferably in the range from 0.001% to 1% by weight, based on the weight of the water absorbent polymer.

To inhibit dusting of the finely divided water-insoluble salt and/or separation of the finely divided water-insoluble salt and water absorbent polymer, it can be advisable for the finely divided water-insoluble salt and/or the water absorbent polymer to be wetted with a dustproofer. Useful dustproofers include low molecular weight compounds which are less volatile than water and are preferably physiologically safe. Examples of suitable dustproofers are polyols, preferably C₁-C₁₀-polyhydroxy compounds such as 1,2-propanediol, 1,3-propanediol, 1,4-butanediol, glycerol and sorbitol. A preferred dustproofer is 1,2-propanediol.

The dustproofer is used in an amount of up to 6% by weight, preferably up to 3% by weight, especially up to 1% by weight and more preferably up to 0.1% by weight, based on the weight of the water absorbent polymer.

The water absorbent polymer can be any water absorbent polymer known from the prior art. Useful water absorbent polymers are in particular polymers of hydrophilic monomers, graft (co)polymers of one or more hydrophilic monomers on a suitable grafting base, crosslinked cellulose or starch ethers, crosslinked carboxymethylcellulose, partially crosslinked polyethers or natural products that are swellable in aqueous fluids, such as guar derivatives, alginates and carrageenans.

Suitable grafting bases may be of natural or synthetic origin. They include starches, i.e., native starches from the group consisting of corn (maize) starch, potato starch, wheat starch, rice starch, tapioca starch, sorghum starch, manioca starch, pea starch or mixtures thereof, modified starches, starch degradation products, for example oxidatively, enzymatically or hydrolytically degraded starches, dextrins, for example roast dextrins, and also lower oligo- and polysaccharides, for example cyclodextrins having from 4 to 8 ring members. Useful oligo- and polysaccharides further include cellulose and starch and cellulose derivatives. It is also possible to use polyvinyl alcohols, polyamines, polyamides, hydrophilic polyester or polyalkylene oxides, especially polyethylene oxide and polypropylene oxide. Useful polyalkylene oxides have the general formula I 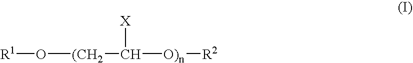
where
R¹, R² are independently hydrogen; C₁-C₄-alkyl; C₂-C₆-alkenyl; aryl, especially phenyl; or (meth)acryloyl;
X is hydrogen or methyl, and
n is an integer from 1 to 1000, especially from 10 to 400.

Polymers of monoethylenically unsaturated acids are preferred as water absorbent polymers. Polymers of monoethylenically unsaturated acids are preferably at least partly present in the form of their salts, especially their alkali metal salts, such as sodium or potassium salts, or as ammonium salts. Polymers of this kind are particularly good at gelling on contact with aqueous fluids.

Particular preference is given to crosslinked water absorbent polymers of monoethylenically unsaturated C₃-C₆-carboxylic acids and/or their alkali metal or ammonium salts. Preference is given in particular to crosslinked polyacrylic acids where from 25 to 100% of the acid groups are present as alkali metal or ammonium salts.

Polymers of this kind are obtained for example on polymerizing monoethylenically unsaturated acids or salts thereof in the presence of crosslinkers. However, it is also possible to polymerize without crosslinker and to crosslink subsequently.

Water absorbent polymers are preferably polymerized from
from 49.9% to 99.9% by weight of at least one monomer A selected from the group consisting of monoethylenically unsaturated acids and salts thereof,
from 0% to 50% by weight, preferably from 0% to 20% by weight, of at least one noncrosslinking monoethylenically unsaturated monomer B other than said monomer A, and
from 0.001% to 20% by weight, preferably from 0.01% to 14% by weight, of at least one crosslinking monomer C.

Useful monomers A include monoethylenically unsaturated mono- and dicarboxylic acids of 3 to 25, preferably 3 to 6, carbon atoms which may also be used as salts or as anhydrides. Examples are acrylic acid, methacrylic acid, ethacrylic acid, α-chloroacrylic acid, crotonic acid, maleic acid, maleic anhydride, itaconic acid, citraconic acid, mesaconic acid, glutaconic acid, aconitic acid and fumaric acid. Useful monomers A further include the monoesters of monoethylenically unsaturated dicarboxylic acids of 4 to 10, preferably 4 to 6, carbon atoms, for example of maleic acid, such as monomethyl maleate. Useful monomers A also include monoethylenically unsaturated sulfonic acids and phosphonic acids, for example vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acid, 2-acrylamido-2-methylpropanesulfonic acid, vinylphosphonic acid and allylphosphonic acid, and the salts, especially the sodium, potassium and ammonium salts, of these acids. The A monomers may be used as such or as mixtures of different A monomers. The weight fractions specified are all based on the acid form.

Preferred A monomers are acrylic acid, methacrylic acid, vinylsulfonic acid, 2-acrylamido-2-methylpropanesulfonic acid or mixtures thereof. Preferred A monomers are acrylic acid and mixtures of acrylic acid with other A monomers, for example mixtures of acrylic acid and methacrylic acid, mixtures of acrylic acid and acrylamidopropanesulfonic acid or mixtures of acrylic acid and vinylsulfonic acid. Acrylic acid is particularly preferably the main constituent of the A monomers.

To optimize properties of the polymers according to the invention, it can be sensible to use additional monoethylenically unsaturated monomers B that differ from the A monomers in that they bear no acid groups, but are copolymerizable with the A monomers and are noncrosslinking. Such compounds include for example monoethylenically unsaturated nitriles such as acrylonitrile, methacrylonitrile, the amides of the aforementioned monoethylenically unsaturated carboxylic acids, e.g., acrylamide, methacrylamide, N-vinylamides such as N-vinylformamide, N-vinylacetamide, N-methylvinylacetamide, N-vinylpyrrolidone and N-vinylcaprolactam. The monomers also include vinyl esters of saturated C₁-C₄-carboxylic acids such as vinyl formate, vinyl acetate and vinyl propionate, alkyl vinyl ethers having at least 2 carbon atoms in the alkyl group, e.g., ethyl vinyl ether or butyl vinyl ether, esters of monoethylenically unsaturated C₃-C₆-carboxylic acids, for example esters of monohydric C₁-C₁₈-alcohols and acrylic acid, methacrylic acid or maleic acid, acrylic and methacrylic esters of alkoxylated monohydric saturated alcohols, for example of alcohols having 10 to 25 carbon atoms which have been reacted with from 2 to 200 mol of ethylene oxide and/or propylene oxide per mole of alcohol, and also monoacrylates and monomethacrylates of polyethylene glycol or polypropylene glycol, the molar masses (Mₙ) of the polyalkylene glycols being up to 2 000, for example. Further suitable monomers are styrene and alkyl-substituted styrenes such as ethylstyrene or tert-butylstyrene.

Useful crosslinking C monomers include compounds having at least two ethylenically unsaturated double bonds in the molecule. Examples of compounds of this type are N,N′-methylenebis-acrylamide, polyethylene glycol diacrylates and polyethylene glycol dimethacrylates each derived from polyethylene glycols having a molecular weight of from 106 to 8 500, preferably from 400 to 2 000, trimethylolpropane triacrylate, trimethylolpropane trimethacrylate, ethylene glycol diacrylate, ethylene glycol dimethacrylate, propylene glycol diacrylate, propylene glycol dimethacrylate, butanediol diacrylate, butanediol dimethacrylate, hexanediol diacrylate, hexanediol dimethacrylate, diethylene glycol diacrylate, diethylene glycol dimethacrylate, triethylene glycol diacrylate, triethylene glycol dimethacrylate, dipropylene glycol diacrylate, dipropylene glycol dimethacrylate, tripropylene glycol diacrylate, tripropylene glycol dimethacrylate, allyl methacrylate, diacrylates and dimethacrylates of block copolymers of ethylene oxide and propylene oxide, di-, tri-, tetra- or pentaacrylated or -methacrylated polyhydric alcohols, such as glycerol, trimethylolpropane, pentaerythritol or dipentaerythritol, esters of monoethylenically unsaturated carboxylic acids with ethylenically unsaturated alcohols such as allyl alcohol, cyclohexenol and dicyclopentenyl alcohol, e.g., allyl acrylate and allyl methacrylate, also triallylamine, dialkyldiallylammonium halides such as dimethyldiallylammonium chloride and diethyldiallylammonium chloride, tetraallylethylenediamine, divinylbenzene, diallyl phthalate, polyethylene glycol divinyl ethers of polyethylene glycols having a molecular weight of from 106 to 4 000, trimethylolpropane diallyl ether, butanediol divinyl ether, pentaerythritol triallyl ether, reaction products of 1 mol of ethylene glycol diglycidyl ether or polyethylene glycol diglycidyl ethers with 2 mol of pentaerythritol triallyl ether or allyl alcohol, and divinylethyleneurea.

Preference is given to water-soluble monomers, i.e., compounds whose solubility in water at 20° C. is at least 50 g/l. These include for example polyethylene glycol diacrylates and polyethylene glycol dimethacrylates, vinyl ethers of addition products of from 2 to 400 mol of ethylene oxide with 1 mol of a diol or polyol, ethylene glycol diacrylate, ethylene glycol dimethacrylate or triacrylates and trimethacrylates of addition products of from 6 to 20 mol of ethylene oxide with 1 mol of glycerol, pentaerythritol triallyl ether and divinylurea.

Useful monomers C further include compounds having at least one ethylenically unsaturated double bond and also at least one further functional group that is complementary in terms of its reactivity to carboxyl groups. Functional groups having complementary reactivity with regard to carboxyl groups include for example hydroxyl, amino, epoxy and aziridino groups. Compounds used include for example hydroxyalkyl esters of the aforementioned monoethylenically unsaturated carboxylic acids, such as 2-hydroxyethyl acrylate, 3-hydroxypropyl acrylate, 4-hydroxybutyl acrylate, 2-hydroxyethyl (meth)acrylate, 3-hydroxypropyl (meth)acrylate and 4-hydroxybutyl (meth)acrylate, allylpiperidinium bromide, N-vinylimidazoles, such as N-vinylimidazole, 1-vinyl-2-methylimidazole and N-vinylimidazolines, such as N-vinylimidazoline, 1-vinyl-2-methylimidazoline, 1-vinyl-2-ethylimidazoline or 1-vinyl-2-propylimidazoline, which are used in the form of the free bases, in quaternized form or as salt in the polymerization. It is also possible to use dimethylaminoethyl acrylate, dimethylaminoethyl methacrylate, diethylaminoethyl acrylate or diethylaminoethyl methacrylate. These basic esters are preferably used in quaternized form or as salt. Glycidyl (meth)acrylate is also useful.

Useful crosslinking monomers C further include compounds having at least two functional groups that are complementary in terms of their reactivity to the carboxyl group of the polymer. Useful functional groups are isocyanate, ester and amido groups as well as the aforementioned functional groups, such as hydroxyl, amino, epoxy and aziridine groups. Useful crosslinkers of this type include for example aminoalcohols, such as ethanolamine or triethanolamine, di- and polyols, such as 1,3-butanediol, 1,4-butanediol, ethylene glycol, diethylene glycol, triethylene glycol, tetraethylene glycol, polyethylene glycol, glycerol, polyglycerol, propylene glycol, polypropylene glycol, trimethylolpropane, pentaerythritol, polyvinyl alcohol, sorbitol, starch, block copolymers of ethylene oxide and propylene oxide, polyamines such as ethylenediamine, diethylenetriamine, triethylenetetramine, tetraethylenepentamine, pentaethylenehexamine and polyethyleneimines and also polyamines having molar masses of up to 4 000 000 in each case, esters such as sorbitan fatty acid esters, ethoxylated sorbitan fatty acid esters, polyglycidyl ethers such as ethylene glycol diglycidyl ether, polyethylene glycol diglycidyl ether, glycerol diglycidyl ether, glycerol polyglycidyl ether, diglycerol polyglycidyl ether, polyglycerol polyglycidyl ether, sorbitol polyglycidyl ether, pentaerythritol polyglycidyl ether, propylene glycol diglycidyl ether and polypropylene glycol diglycidyl ether, polyaziridine compounds such as 2,2-bishydroxymethylbutanol tris[3-(1-aziridinyl)propionate], diamides of carbonic acid, such as 1,6-hexamethylenediethyleneurea, diphenylmethanebis-4,4′-N,N′-diethyleneurea, haloepoxy compounds, such as epichlorohydrin and α-methylepifluorohydrin, polyisocyanates, such as 2,4-tolylene diisocyanate and hexamethylene diisocyanate, alkylene carbonates such as 1,3-dioxolan-2-one and 4-methyl-1,3-dioxolan-2-one, also bisoxazolines and oxazolidones, polyamidoamines and also their reaction products with epichlorohydrin, also polyquaternary amines, such as condensation products of dimethylamine with epichlorohydrin, homo- and copolymers of diallyldimethylammonium chloride and also homo- and copolymers of dimethylaminoethyl (meth)acrylate which have optionally been quaternized with, for example, methyl chloride.

The water absorbent polymers can be prepared by subjecting the monomers A, B and C to a free radical polymerization in aqueous solution, optionally in the presence of a suitable grafting base. The polymerization may be effected not only in homogeneous aqueous phase but also as a suspension polymerization, in which case the aqueous solution of the monomers forms the disperse phase.

Polymerization in aqueous solution is preferably conducted as gel polymerization. It involves for example a 10-70% by weight aqueous solution of the monomers A, B and C being polymerized optionally in the presence of a suitable grafting base, by means of a polymerization initiator by utilizing the Trommsdorff-Norrish effect.

The polymerization is generally carried out in the temperature range from 0° C. to 150° C., preferably in the range from 10° C. to 100° C., and may be carried out not only at atmospheric pressure but also at superatmospheric or reduced pressure. As is customary, the polymerization may also be conducted in a protective gas atmosphere, preferably under nitrogen.

Industrial processes useful for preparing these products include all processes which are customarily used to make superabsorbents. Suitable measures are described for example in “Modern Superabsorbent Polymer Technology”, F. L. Buchholz and A. T. Graham, Wiley-VCH, 1998, chapter 3, incorporated herein by reference. Useful polymerization reactors include the customary production reactors, especially belt reactors and kneaders in the case of solution polymerization (see “Modern Superabsorbent Polymer Technology”, section 3.2.3). The polymers are particularly preferably produced by a continuous or batchwise kneading process.

Suitable initiators include in principle all compounds which decompose into free radicals on heating to the polymerization temperature. The polymerization may be initiated by the action of high energy radiation, for example UV radiation, in the presence of photoinitiators. Initiation of the polymerization by the action of electron beams on the polymerizable, aqueous mixture is also possible.

Suitable initiators include for example peroxo compounds such as organic peroxides, organic hydroperoxides, hydrogen peroxide, persulfates, perborates, azo compounds and redox catalysts. Water-soluble initiators are preferred. In some cases it is advantageous to use mixtures of different polymerization initiators, for example mixtures of hydrogen peroxide and sodium peroxodisulfate or potassium peroxodisulfate. Useful organic peroxides include for example acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, di(2-ethylhexyl) peroxodicarbonate, dicyclohexyl peroxodicarbonate, di(4-tert-butylcyclohexyl) peroxodicarbonate, dimyristyl peroxodicarbonate, diacetyl peroxodicarbonate, allyl peresters, cumene peroxyneodecanoate, tert-butyl per-3,5,5-trimethylhexanoate, acetyl cyclohexylsulfonyl peroxide, dilauryl peroxide, dibenzoyl peroxide and tert-amyl perneodecanoate. Particularly useful polymerization initiators include water-soluble azo initiators, e.g., 2,2′-azobis(2-amidinopropane) dihydrochloride, 2,2′-azobis(N,N′-dimethylene)isobutyramidine dihydrochloride, 2-(carbamoylazo)isobutyronitrile, 2,2′-azobis[2-(2′-imidazolin-2-yl)propane] dihydrochloride and 4,4′-azobis(4-cyanovaleric acid). The polymerization initiators mentioned are used in customary amounts, for example in amounts of from 0.01 to 5%, preferably from 0.05 to 2.0%, by weight, based on the monomers to be polymerized.

Redox initiators, which are preferred, are water-soluble initiators and include as the oxidizing component at least one of the above-specified peroxo compounds and as the reducing component for example ascorbic acid, glucose, sorbose, ammonium or alkali metal sulfite, bisulfite, thiosulfate, hyposulfite, pyrosulfite or sulfide, metal salts, such as iron(II) ions or sodium hydroxymethylsulfoxylate. The reducing component in the redox catalyst is preferably ascorbic acid or sodium sulfite. Based on the amount of monomers used in the polymerization, from 3×10⁻⁶ to 1 mol % of the reducing component of the redox catalyst system and from 0.001 to 5.0 mol % of the oxidizing component of the redox catalyst is used, for example.

When the polymerization is initiated using high energy radiation, the initiator used is customarily a photoinitiator.

Polymers prepared by polymerization of the abovementioned monoethylenically unsaturated acids with or without monoethylenically unsaturated comonomers and typically having a molecular weight of above 5000, preferably above 50 000, are postcrosslinked by reacting them with compounds having at least two groups that are reactive toward acid groups. This reaction may take place at room temperature or else at elevated temperatures of up to 220° C. The crosslinkers used are the aforementioned monomers C, which have at least two functional groups having complementary reactivity with regard to carboxyl groups.

The crosslinkers for postcrosslinking are added to the resultant polymers in amounts of from 0.5 to 20% by weight, preferably from 1 to 14% by weight, based on the amount of the polymer.

The polymers of the invention are generally obtained after polymerization as hydrogels having a moisture content of for example from 0% to 90%, usually from 20% to 90%, by weight, which are generally initially coarsely comminuted by known methods. Coarse comminution of the hydrogels is effected by means of customary tearing and/or cutting tools, for example by the action of a discharge pump in the case of polymerization in a cylindrical reactor or by a cutting roll or cutting roll combination in the case of belt polymerization.

When the A monomers have not been used in neutralized form, the acidic polymer obtained can be adjusted to the desired degree of neutralization of generally at least 25 to 90 mol %, preferably from 50 to 80 mol %, especially from 65 to 80 mol %, most preferably from 70 to 78 mol % based on acid-functional monomer units. Alternatively, the degree of neutralization may also be adjusted before or during the polymerization, for example in a kneader.

Useful neutralizing agents include alkali metal bases or ammonia/amines. Preference is given to the use of aqueous sodium hydroxide solution or aqueous potassium hydroxide solution. However, neutralization may also be effected using sodium carbonate, sodium bicarbonate, potassium carbonate or potassium bicarbonate or other carbonates or bicarbonates or ammonia. Moreover, primary, secondary and tertiary amines may be used for neutralization.

The water absorbent polymer typically has a pH in the range from 4.0 to 7.5, preferably in the range from 5.0 to 7.5, especially in the range from 5.5 to 7.0 and most preferably in the range from 5.5 to 6.5.

The thus obtained, preferably (partially) neutralized polymer is subsequently dried at elevated temperature, for example in the range from 80° C. to 250° C., especially in the range from 100° C. to 180° C., by known processes (see “Modern Superabsorbent Polymer Technology” section 3.2.5). This provides the polymers in the form of powders or granules which, if appropriate, are additionally subjected to several grinding and classifying operations to set the particle size (see “Modern Superabsorbent Polymer Technology” sections 3.2.6 and 3.2.7).

Preferably, the particulate polymers obtained are then surface postcrosslinked. To effect surface postcrosslinking, compounds capable of reacting with the acid functional groups on crosslinking are applied to the surface of the polymer particles, preferably in the form of an aqueous solution. The aqueous solution may contain water-miscible organic solvents. Suitable solvents are alcohols such as methanol, ethanol, i-propanol or acetone.

Suitable postcrosslinkers include for example:
di- or polyglycidyl compounds such as diglycidyl phosphonates or ethylene glycol diglycidyl ether, bischlorohydrin ethers of polyalkylene glycols,
alkoxysilyl compounds,
polyaziridines, aziridine compounds based on polyethers or substituted hydrocarbons, for example bis-N-aziridinomethane,
polyamines or polyamidoamines and also their reaction products with epichlorohydrin,
polyols such as ethylene glycol, 1,2-propanediol, 1,4-butanediol, glycerol, methyltriglycol, polyethylene glycols having an average molecular weight M_{w} of 200-10 000, di- and polyglycerol, pentaerythritol, sorbitol, the ethoxylates of these polyols and their esters with carboxylic acids or carbonic acid such as ethylene carbonate or propylene carbonate,
carbonic acid derivatives such as urea, thiourea, guanidine, dicyandiamide, 2-oxazolidinone and its derivatives, bisoxazoline, polyoxazolines, di- and polyisocyanates,
di- and poly-N-methylol compounds such as, for example, methylenebis(N-methylolmethacrylamide) or melamine-formaldehyde resins,
compounds having two or more blocked isocyanate groups such as, for example, trimethylhexamethylene diisocyanate blocked with 2,2,3,6-tetramethylpiperidin-4-one,
salts of polyvalent metals, such as for example aluminum sulfate.

If necessary, acidic catalysts may be added, for example p-toluenesulfonic acid, phosphoric acid, boric acid or ammonium dihydrogenphosphate.

Particularly suitable postcrosslinkers are di- or polyglycidyl compounds such as ethylene glycol diglycidyl ether, the reaction products of polyamidoamines with epichlorohydrin and 2-oxazolidinone.

The crosslinker solution is preferably applied by spraying with a solution of the crosslinker in conventional reaction mixers or mixing and drying equipment such as Patterson-Kelly mixers, DRAIS turbulence mixers, Lödige mixers, screw mixers, plate mixers, fluidized bed mixers and Schugi-Mix. The spraying of the crosslinker solution may be followed by a heat treatment step, preferably in a downstream dryer, at from 80 to 230° C., preferably at from 80 to 190° C., particularly preferably at from 100 to 160° C., for from 5 minutes to 6 hours, preferably from 10 minutes to 2 hours, particularly preferably from 10 minutes to 1 hour, during which not only cracking products but also solvent fractions can be removed. But the drying may also take place in the mixer itself, by heating the jacket or by blowing in a preheated carrier gas. If desired, the crosslinker solution includes at least one surfactant.

The particle size of the water absorbent polymer is typically less than 850 μm, preferably in the range from 100 to 600 μm and especially in the range from 100 to 500 μm.

The level of extractables after 16 hours of extraction (with 0.9% by weight aqueous NaCl solution) is typically less than 30% by weight, preferably less than 22% by weight and especially less than 15% by weight, based on the weight of the water absorbent polymer.

The water absorbent of the present invention may further include a carrier. The carrier is usually a fiber material selected from the group consisting of cellulose, modified cellulose, rayon, polyester, polyester such as polyethylene terephthalate, polypropylene, hydrophilicized nylon, polyethylene, polyacrylic, polyamides, polystyrene, polyurethane and polyacrylonitrile. It is particularly preferable to use cellulosic fibers such as pulp. The diameter of the fibers is generally in the range from 1 to 200 μm and preferably in the range from 10 to 100 μm. In addition, the fibers are preferably about 1 mm in minimum length.

The fraction of fiber material, based on the total amount of water absorbent polymer, is typically up to 10 000% by weight, preferably in the range from 0 to 100% by weight and most preferably less than 60% by weight.

The production of the water absorbent of the present invention starts with a particulate water absorbent polymer which is present in dried form or as a comminuted hydrogel and involves the particles being contacted with the nitrogenous polymer, for example by having the nitrogenous polymer, preferably in the form of a solution, applied onto the surface of the particles of the water absorbent polymer. There generally follows a final drying step. Alternatively, the particles of the water absorbent polymer can be contacted with a carrier onto which the nitrogenous polymer has previously been applied.

Useful solvents for the nitrogenous polymer include water or organic solvents, such as alcohols, for example methanol, ethanol and isopropanol, ketones, for example acetone and methyl ethyl ketone, or mixtures of water with the aforementioned organic solvents. When the nitrogenous polymer used is a (partially) hydrolyzed polyvinylamide, the solution obtained in the (partial) hydrolysis can be used directly. The concentration of the nitrogenous polymer in the solvent can be varied within wide limits. It is generally in the range from 0.1% to 20% by weight and preferably in the range from 1% to 15% by weight.

If desired, the solution of the nitrogenous polymer can include a surfactant. Alternatively, the application of the solution of the nitrogenous polymer can be preceded by the application of a surfactant onto the water absorbent polymer. The surfactant can be applied during the surface postcrosslinking step for example. The surfactant serves to lower the surface tension of the solution and to promote uniform wetting. Useful surfactants include nonionic, anionic and cationic surfactants and also mixtures thereof. The water absorbent preferably includes nonionic surfactants. Examples of suitable nonionic surfactants are sorbitan esters, such as the mono-, di- or triesters of sorbitans with C₈-C₁₈-carboxylic acids such as lauric, palmitic, stearic and oleic acids; polysorbates; alkylpolyglucosides having from 8 to 22 and preferably from 10 to 18 carbon atoms in the alkyl chain and from 1 to 20 and preferably from 1.1 to 5 glucoside units; N-alkylglucamides; alkylamine alkoxylates or alkylamide ethoxylates; alkoxylated C₈-C₂₂-alcohols such as fatty alcohol alkoxylates or oxo process alcohol alkoxylates; block polymers of ethylene oxide, propylene oxide and/or butylene oxide; alkylphenol ethoxylates having C₆-C₁₄-alkyl chains and from 5 to 30 mol of ethylene oxide units.

The amount of surfactant is generally in the range from 0.01% to 0.5% by weight, preferably less than 0.1% by weight and is in particular below 0.05% by weight, based on the weight of the water absorbent polymer.

In a preferred embodiment, the solution of the nitrogenous polymer is sprayed onto the water absorbent polymer in a reaction mixer or mixing and drying equipment such as for example a Patterson-Kelly mixer, DRAIS turbulence mixer, Lbdige mixer, screw mixer, plate mixer, fluidized bed mixer or Schugi-Mix. The application generally takes place at temperatures in the range from room temperature to 100° C. The application is typically carried out following the drying of the (surface) postcrosslinked and frequently still warm particles of the water absorbent polymer.

The spraying of the solution is typically followed by a heat treatment step, preferably in a downstream dryer, at from 40 to 140° C., preferably from 40 to 120° C. and more preferably from 60 to 120° C. The heat aftertreatment step is typically carried on until the water absorbent has been dried to the desired degree. The residual moisture content is generally below 5% by weight, preferably below 3% by weight, more preferably below 2% by weight and most preferably in the range from 0.01% to 1% by weight, based on the weight of the water absorbent. But the drying may also take place in the mixer itself, by heating the jacket or by blowing in a preheated carrier gas. The heat aftertreatment step improves the flowability of the water absorbent.

The SFC value of the water absorbent obtained admittedly increases at drying temperatures of more than 140° C., but the wet strength of the water absorbent deteriorates. It is believed that an excessive number of covalent bonds form between the nitrogenous polymer and, for example, the carboxyl groups of the water absorbent polymer at high temperatures. This causes a reduction in the mobility of the nitrogenous polymer and in the ability of the nitrogenous polymer to link one particle of the water absorbent polymer to another.

Alternatively, it is also possible for the aforementioned carrier to be coated with the nitrogenous polymer, for example by spraying with a solution of the nitrogenous polymer. The coated carrier is subsequently thoroughly mixed with the particles of the water absorbent polymer or the coated carrier is placed directly adjacent the water absorbent polymer.

When a finely divided water-insoluble salt and the optional dustproofer are used, the application of or mixing with these constituents can take place before, at the same as or after the application of the nitrogenous polymer.

The finely divided water-insoluble salt can be applied by intimate mixing for example. Typically, the finely divided water-insoluble salt is added at room temperature to the particulate water absorbent polymer and mixed in until a homogeneous mixture is present. Mixing can be effected using customary apparatus, for example a drum mixer, a belt screw mixer or a silo screw mixer. The mixing with the finely divided water-insoluble salt can take place before or after any surface postcrosslinking, for example during the heat aftertreatment step following the application of the postcrosslinking agent.

The dustproofer is conveniently applied in the form of an aqueous solution, preferably during or after the intimate mixing with the water-insoluble salt. The dustproofer can also be included in the solution of the nitrogenous polymer.

The water absorbent of the present invention is very useful as an absorbent for water and aqueous fluids, especially body fluids.

It can beneficially be used for producing hygiene articles such as diapers, incontinence pads and briefs, tampons or sanitary napkins. It is further useful for absorbing wound fluid in plasters, compresses and other wound contact materials. It is further useful for soil improvement, for example as a water retainer in market gardening.

Examples hereinbelow illustrate the invention.

I. Description of Test Methods

1. Centrifuge Retention Capacity (CRC)

This method measures the free swellability of the hydrogel-forming polymer in a teabag. 0.2000±0.0050 g of dried polymer is sealed into a teabag 60×85 mm in size. The teabag is then soaked for 30 minutes in 0.9% by weight saline solution (at least 0.83 l of saline/1 g of polymer powder). The teabag is then centrifuged for 3 minutes at 250 G. The amount of liquid absorbed is determined by weighing the centrifuged teabag.

2. Absorbency Under Load (AUL) (0.7 psi)

The measuring cell for determining AUL 0.7 psi is a Plexiglas cylinder 60 mm in internal diameter and 50 mm in height. Adhesively attached to its underside is a stainless steel mesh floor having a mesh size of 36 μm. The measuring cell further includes a plastic plate having a diameter of 59 mm and a weight which can be placed in the measuring cell together with the plastic plate. The weight of the plastic plate and the weight totals 1345 g. AUL 0.7 psi is determined by measuring the weight of the empty Plexiglas cylinder and of the plastic plate and recording it as W₀. 0.900±0.005 g of water absorbent polymer is then weighed into the Plexiglas cylinder and distributed very uniformly over the stainless steel mesh floor. The plastic plate is then carefully placed in the Plexiglas cylinder, the entire unit is weighed and the weight is recorded as Wₐ. The weight is then placed on the plastic plate in the Plexiglas cylinder. A ceramic filter plate 120 mm in diameter and 0 in porosity is then placed in the middle of a Petri dish 200 mm in diameter and 30 mm in height and sufficient 0.9% by weight sodium chloride solution is introduced for the surface of the liquid to be level with the filter plate surface without the surface of the filter plate being wetted. A round filter paper 90 mm in diameter and <20 μm in pore size (S&S 589 Schwarzband from Schleicher & Schüll) is subsequently placed on the ceramic plate. The Plexiglas cylinder containing water absorbent polymer is then placed with plastic plate and weight on top of the filter paper and left there for 60 minutes. At the end of this period, the complete unit is removed from the filter paper and Petri dish and subsequently the weight is removed from the Plexiglas cylinder. The Plexiglas cylinder containing swollen hydrogel is weighed together with the plastic plate and the weight recorded as W_{b}.

AUL is calculated by the following equation:
AUL 0.7 psi [g/g]=[W_{b}−Wₐ]/[Wₐ−W₀]
3. Saline Flow Conductivity (SFC)

The test method for determining SFC is described in U.S. Pat. No. 5,599,335.

4. Ball Burst Strength (BBS)

The test method for determining the BBS (30 min) value, ie 30 minutes elapse from the start of the swelling of the superabsorbent to the measurement, is described in U.S. Pat. No. 6,121,509. The determination of the BBS (16 h) value is similar to the determination of the BBS (30 min) value, except that 16 hours elapse from the start of the swelling of the superabsorbent to the measurement. In departure from U.S. Pat. No. 6,121,509, the stock reservoir vessel is on the balance and the measuring cells are on height-adjustable platforms. After 30 minutes or 16 hours, as the case may be, the steel weight is removed and the sample is transferred into the measuring apparatus for measurement. The BBS value is a measure of the wet strength of the water absorbent polymer.

The relative decrease in BBS (16 h vs. 30 min) is calculated as follows:

$$BBS decrease = \frac{BBS ( 30 min ) - BBS ( 16 h )}{BBS ( 30 min )} \times 100 \%$$

5. Extractable Content (16 h)

The extractable content after 16 hours is determined in accordance with ISO/DIS 17190-10 (obtainable through EDANA (European Disposables and Nonwovens Association)).

### II PREPARATION EXAMPLES

### EXAMPLES

Preparation of a Surface-Postcrosslinked Polymer

Acrylic acid, sodium acrylate and ethoxylated trimethylolpropane triacrylate were polymerized in a conventional process to prepare a base polymer having a Centrifuge Retention Capacity of 30-31 g/g and a degree of neutralization of 75 mol % for the acrylic acid. The as-polymerized gel was mechanically comminuted. The comminuted gel was then dried in a laboratory drying cabinet, ground using a laboratory roll mill and finally sieved off at from 150 to 850 μm. The base polymer obtained was sprayed with an aqueous surface postcrosslinker solution (0.08% by weight of oxazolidinone, 0.02% by weight of sorbitan monolaurate and 3.5% by weight of 1,2-propanediol, each percentage being based on the base polymer) and then with 0.5% by weight of aluminum sulfate (as an aqueous 26.8% solution, based on the base polymer) by means of a two-material nozzle in a powder mixing assembly and heat treated at 175-180° C. for about 80 min. After cooling to room temperature, the powder was sieved off to a particle size of 150-850 μm to remove clumps. The polymer had the following particle size distribution: 0.14% above 850 μm, 35.8% of 300-600 μm, 63.3% of 150-300 μm and less than 0.1% below 150 μm. The characteristic numbers of the polymer are reported in table 1 for comparison.

1 200 g of the polymer prepared above were placed into a 5 l Lödige plowshare laboratory mixer at room temperature and thereafter sprayed with 65.71 g of a 7.3% by weight aqueous polyvinylamine solution having different degrees of hydrolysis (ex. 1: Basocoll PR 8086, degree of hydrolysis 95 mol %; example 2: Basocoll Pr 8092, degree of hydrolysis 75 mol %; ex. 3: Luredur PR 8097, degree of hydrolysis 44 mol %; ex. 4: Basocoll PR 8095, degree of hydrolysis 31 mol %; ex. 5: Basocoll PR 8094, degree of hydrolysis 14 mol %, each having a weight average molecular weight of about 400 000 daltons) by means of a two-material nozzle (nitrogen fed as atomizing gas at a pressure of about 1 bar, the liquid via a pump) for 13 minutes while mixing at 200 rpm. The product obtained was subsequently transferred to a similar preheated Lödige plowshare laboratory mixer and dried at 100° C. and at 50 rpm in the course of about 60 min. The fraction of the nitrogenous polymer was in each case 0.4% by weight, based on the absorbent polymer. The characteristic numbers of the product obtained are reported in table 1 below.

As can be seen in table 1, the SFC and BBS values in examples 2 and 3 increased distinctly as compared with the noninventive examples.

The storage stability of the water absorbent was also tested. The results are reported in table 2 below. The water absorbents in examples 6 to 10 were prepared in the manner described above (examples 6 and 7: Basocoll PR 8144, purified by ultrafiltration to remove the by-products of hydrolysis, degree of hydrolysis 95 mol %; examples 8, 9 and 10: Luredur PR 8097, degree of hydrolysis 44 mol %). The fraction of the nitrogenous polymer was in each case 0.4% by weight, based on the absorbent polymer. However, the water absorbent in example 10 was sieved off to a particle size of 150-500 μm. The measurements were carried out directly after preparation in examples 6, 8 and 10 and after 14 days of storage at 60° C. in examples 7 and 9.

The results of table 2 document that, following dry storage for 14 days at 60° C., the decrease in BBS and AUL in inventive example 9 is distinctly less than in comparative example 7. The results further show that the particle size distribution of the polymer has an effect on SFC and BBS.

TABLE 1

| | | Protonatable | | | | BBS | | AUL |
|---|---|---|---|---|---|---|---|---|
| | | nitrogen | SFC | | | decrease | | 0.7 |
| | HG* | atoms | ×10⁻⁷ | BBS (30 min) | BBS (16 h) | (30 min → | CRC | psi |
| Example | [mol %] | [mol/kg] | [cm³ · s/g] | [gf] | [gf] | 16 h) [%] | [g/g] | [g/g] |
| Comp. | — | — | 111 | <10 | <10 | — | 27.5 | 23.4 |
| 1** | 95 | 21.4 | 133 | 169 | 160 | 5 | 27.1 | 19.0 |
| 2 | 75 | 15.0 | 138 | 196 | 150 | 23 | 26.9 | 19.2 |
| 3 | 44 | 7.5 | 229 | 169 | 110 | 35 | 27.3 | 20.6 |
| 4 | 31 | 5.0 | 104 | 55 | 27 | 51 | 26.9 | 21.9 |
| 5** | 14 | 2.1 | 111 | 21 | — | — | 26.9 | 21.1 |

HG*: degree of hydrolysis
**comparative example

TABLE 2

| | Weight | | | | | | | | |
|---|---|---|---|---|---|---|---|---|---|
| | average | | | | | | | | |
| | molecular | | | | | | | | |
| | weight of | | Protonatable | | | | | | Particle |
| | polyvinyl- | | nitrogen | | SFC | BBS | | AUL | size of |
| | amine | HG* | atoms | Storage | ×10⁻⁷ | (30 min) | CRC | 0.7 psi | polymer |
| Example | [dalton] | [mol %] | [mol/kg] | state | [cm³ · s/g] | [gf] | [g/g] | [g/g] | [μm] |
| 6** | 35 000 | 95 | 21.4 | freshly | 150 | 137 | 26.9 | 20.2 | 150-850 |
| | | | | prepared | | | | | |
| 7** | 35 000 | 95 | 21.4 | stored dry | 255 | 73 | 26.8 | 19.1 | 150-850 |
| | | | | at 60° C. for | | | | | |
| | | | | 14 days | | | | | |
| 8 | 400 000 | 44 | 7.5 | freshly | 229 | 169 | 27.3 | 20.6 | 150-850 |
| | | | | prepared | | | | | |
| 9 | 400 000 | 44 | 7.5 | stored dry | 200 | 160 | 26.9 | 20.5 | 150-850 |
| | | | | at 60° C. for | | | | | |
| | | | | 14 days | | | | | |
| 10 | 400 000 | 44 | 7.5 | freshly | 154 | 184 | 26.7 | 20.3 | 150-500 |
| | | | | prepared | | | | | |

HG*: degree of hydrolysis
**comparative example

1. A water absorbent comprising
(a) particles of a water absorbent polymer, and
(b) a nitrogenous polymer containing from 5 to 17 mol/kg, based on the total weight of the nitrogenous polymer, of protonatable nitrogen atoms.

2. The water absorbent of claim 1, wherein the nitrogenous polymer is a hydrolysis product of a homo- or copolymer of an N-vinylcarboxamide, and/or N-vinylcarboximide, or a mixture thereof.

3. The water absorbent of claim 1 having
a particle size distribution wherein more than 98% by weight of the particles are from 100 to 850 μm in size,
a Saline Flow Conductivity of at least 30×10⁻⁷ cm³ s/g,
a Ball Burst Strength (30 min) of at least 50 gf,
a Ball Burst Strength (16 h) of at least 50 gf, and
a quotient [BBS (30 min)—BBS (16 h)]/BBS (30 min) of less than 0.8.

4. The water absorbent of claim 2 wherein the nitrogenous polymer is a hydrolysis product of a homopolymer of N-vinylformamide having a degree of hydrolysis in the range from 30 to 80 mol %.

5. The water absorbent of claim 1 wherein the nitrogenous polymer has a weight average molecular weight in the range from 10 000 to 500 000 daltons.

6. The water absorbent of claim 1 comprising from 0.001% to 5% by weight of the nitrogenous polymer, based on the weight of the water absorbent polymer.

7. The water absorbent of claim 1 further comprising a finely divided water-insoluble salt.

8. The water absorbent of claim 1 wherein the water absorbent polymer is polymerized from
from 49.9% to 99.9% by weight of at least one monomer A selected from the group consisting of monoethylenically unsaturated acids and salts thereof,
from 0% to 50% by weight of at least one monoethylenically unsaturated monomer B other than said monomer A, and
from 0.001% to 20% by weight of at least one crosslinking monomer C.

9. The water absorbent claim 1 wherein the particles of the water absorbent polymer are surface postcrosslinked.

10. The water absorbent claim 1 further comprising a carrier selected from the group consisting of cellulose, modified cellulose, rayon, polypropylene, polyester, hydrophilicized nylon, polyethylene, polycarylic, polyamide, polystyrene, polyurethane, and polyacrylonitrile.

11. The water absorbent as claimed in claim 10 wherein the nitrogenous polymer is applied onto the carrier.

12. A process for producing a water absorbent of claim 1 comprising applying the nitrogenous polymer or a solution thereof onto the particles of the water absorbent polymer and, if necessary, drying the water absorbent.
